(19) United States
(12) Patent Application Publication
(10) Pub. No.: US 2017/0095385 A1
(43) Pub. Date: Apr. 6, 2017

(54) PATIENT SUPPORT APPARATUS HAVING AIR FLUIDIZED THERAPY

(71) Applicant: Hill-Rom Services, Inc., Batesville, IN (US)

(72) Inventors: Brian J. Hoffman, Lawrenceburg, IN (US); Nicole Johannigman, Greensburg, IN (US); Frank Sauser, Cincinnati, OH (US); Brandon P. Fisk, Greensburg, IN (US); Gregory J. Shannon, Indianapolis, IN (US); David C. Newkirk, Lawrenceburg, IN (US); Eric R. Meyer, Batesville, IN (US); Joseph T. Canter, Harrison, OH (US); Nancy H. Strzelecki, Cleves, OH (US); William H. Phipps, Oldenburg, IN (US)

(21) Appl. No.: 15/265,194

(22) Filed: Sep. 14, 2016

Related U.S. Application Data
(60) Provisional application No. 62/236,320, filed on Oct. 2, 2015.

(51) Int. Cl. A61G 7/05; A47C 27/08; A61G 7/018; A47C 27/10; A61G 7/015

(52) U.S. Cl. CPC A61G 7/05; A47C 27/10; A61G 7/015; A61G 7/018; A47C 27/082

(57) ABSTRACT

A patient support apparatus comprises a fluidization therapy bed. The fluidization therapy bed includes a fluidization space and a fluidizable medium positioned in the fluidization space. The patient support apparatus receives a flow of pressurized air from an air supply that fluidizes the fluidizable medium to provide an air fluidized therapy to a patient supported on the patient support apparatus.

The present application claims the benefit, under 35 U.S.C. §119(e), of U.S. Provisional Application No. 62/236,320, filed Oct. 2, 2015, and which is hereby incorporated by reference herein in its entirety.

### BACKGROUND

The present disclosure relates to patient support apparatuses, such as hospital beds, for example, which include active support surfaces. More specifically, the present disclosure relates to patient support apparatuses that provide an air fluidized therapy.

Air fluidized therapy provides minimal shear and frictional force to the skin of a patient occupying the hospital bed. Reducing shear and frictional forces between the patient and the bed improves healing conditions when a patient is recovering from skin trauma. As an example, skin trauma may be caused by burns as well as skin grafts performed as surgical treatment for the burns.

Air fluidized therapy may be periodically stopped such that the bed no longer provides the desired support for improving healing conditions. For example, the air fluidized therapy may be stopped when the patient exits the bed or while a second therapy is performed. The patient or a caregiver of the patient may forget to initiate the air fluidized therapy after the patient returns to bed or after the second therapy ends.

### SUMMARY

The present application discloses one or more of the features recited in the appended claims and/or the following features which, alone or in any combination, may comprise patentable subject matter:

According to a first aspect of the present disclosure, an air fluidization therapy bed may comprise a fluidization system, a tank assembly, a head end support assembly, and a quick release handle. The tank assembly may include a fluidization space and a fluidizable medium positioned in the fluidization space. The tank assembly may be configured to receive a flow of pressurized air from the fluidization system to fluidize the fluidizable medium to cause the tank assembly to provide air fluidized therapy to a patient supported on the air fluidization therapy bed. The head end support assembly may include a plurality of inflatable bladders. The head end support assembly may be configured to variably incline relative to the tank assembly. The quick release handle may be configured to cause the head end support assembly to rapidly lower into a horizontal position and to instruct the fluidization system to draw down at least one of the plurality of inflatable bladders when the quick release handle is activated.

In some embodiments, the air fluidization therapy bed may further include a controller configured to instruct fluidization system to stop the air fluidized therapy when the quick release handle is activated. In some embodiments, the fluidization system may be configured to draw down each of the plurality of inflatable bladders when the quick release handle is activated.

In some embodiments, the air fluidization therapy bed may further include a control interface configured to allow a user to initiate and stop the air fluidized therapy. The controller may be configured to instruct the control interface to display a notification informing the user that the air fluidization therapy has been stopped for a predetermined amount of time after the predetermined amount of time has elapsed.

In some embodiments, the air fluidization therapy bed may further include a control interface configured to allow a user to initiate and stop the air fluidized therapy and a controller. The controller may be configured to instruct the control interface to display a notification informing the user that the air fluidization therapy has been stopped for a predetermined amount of time after the predetermined amount of time has elapsed.

In some embodiments, the predetermined amount of time may be about 30 minutes. In some embodiments, the air fluidization therapy bed may further include a controller configured to instruct the fluidization system to stop the air fluidized therapy when the quick release handle is activated.

In some embodiments, the controller may be further configured to detect if a patient is supported on the air fluidization therapy bed. The controller may instruct the control interface to display the notification only if a patient is detected.

According to another aspect of the present disclosure a method of operating an air fluidization therapy bed may include reclining a head end support assembly included in the air fluidization therapy bed relative to a tank assembly in response to a quick release handle being pulled, the tank assembly including a fluidization space and a fluidizable medium positioned in the fluidization space and the head end support assembly having a plurality of inflatable bladders, the tank assembly configured to provide air fluidized therapy to a patient supported on the air fluidization therapy bed, and the head end support assembly configured to variably incline relative to the tank assembly; and drawing down with a vacuum the plurality of inflatable bladders included in the head end support assembly in response to the quick release handle being pulled.

In some embodiments, the method may further include stopping air fluidization therapy being provided by the air fluidization therapy bed in response to the quick release handle being pulled. In some embodiments, the method may further include displaying a notification screen on a graphical interface that the air fluidization therapy has been stopped for a predetermined amount of time after the predetermined amount of time has passed. In some embodiments, the notification screen may include an option to turn on the air fluidization therapy.

In some embodiments, reclining the head end support assembly and drawing down the inflatable bladders may cause an upper body portion of the patient to have less than a 10 degree incline relative to a lower body portion of the patient. In some embodiments, drawing down with a vacuum the plurality of inflatable bladders may completely deflate the plurality of inflatable bladders.

According to another aspect of the present disclosure, an air fluidization therapy bed may comprise a tank assembly, a control interface, and a controller. The assembly may include a fluidization space and a fluidizable medium positioned in the fluidization space. The tank assembly may be configured to receive a flow of pressurized air from an air supply to fluidize the fluidizable medium to cause the tank assembly to provide air fluidized therapy to a patient supported on the air fluidization therapy bed. The control interface may be configured to allow a user to initiate and stop the air fluidized therapy. The controller may be configured to instruct the control interface to display a notification informing the user that the air fluidization therapy has been stopped for a predetermined amount of time after the air fluidization therapy has been stopped for the predetermined amount of time.

In some embodiments, the predetermined amount of time may be about 30 minutes. In some embodiments, the air fluidization therapy bed may further include a head section that includes a plurality of inflatable support bladders. The head section may be configured to variably incline relative to the tank assembly.

In some embodiments, the controller may be further configured to detect if a patient is supported on the air fluidization therapy bed. The controller may instruct the control interface to display the notification only if a patient is detected.

According to another aspect of the present disclosure a method of operating an air fluidization therapy bed may include stopping an air fluidization therapy provided by the air fluidization therapy bed, the air fluidization therapy bed comprising a tank assembly including a fluidization space and a fluidizable medium positioned in the fluidization space, the tank assembly configured to receive a flow of pressurized air to fluidize the fluidizable medium to cause the tank assembly to provide air fluidized therapy to a patient supported on the air fluidization therapy bed; and displaying a notification screen on a control interface included in the air fluidization therapy bed that the air fluidization therapy has been stopped for a predetermined amount of time after the predetermined amount of time has passed.

In some embodiments, the notification screen may include an option to turn on the air fluidization therapy.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a patient support apparatus, the patient support apparatus includes a tank assembly configured to provide air fluidized therapy to a patient supported on the patient support apparatus and a head end support assembly configured to variably incline relative to the tank assembly;

FIG. 2 is perspective view of the patient support apparatus of FIG. 1 showing an enlarged control interface included in the patient support apparatus;

FIG. 3 is a block diagram showing elements of the patient support apparatus of FIG. 1;

FIG. 4 is a diagrammatic view of a patient occupying the patient support apparatus of FIG. 1; and

FIG. 5 is a diagrammatic view of illustrative screens that may be displayed on the control interface included in the patient support apparatus of FIG. 1.

### DETAILED DESCRIPTION OF THE DRAWINGS

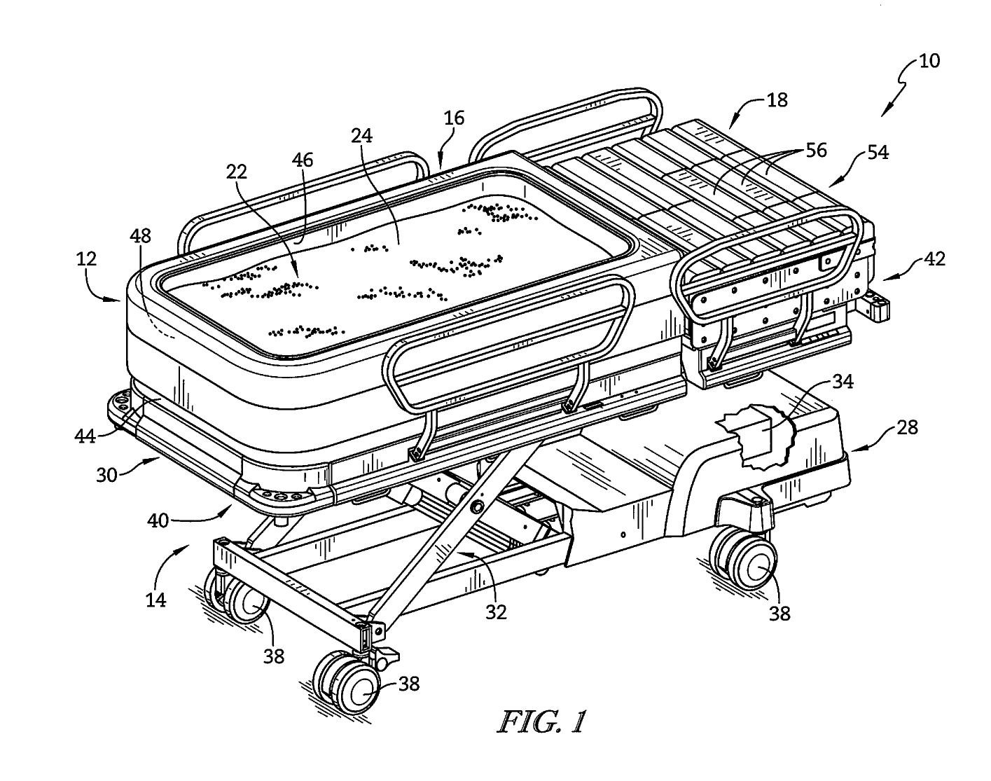

An illustrative patient support apparatus 10 is shown in FIG. 1. Patient support apparatus 10 includes an air fluidization bed 12 and a carriage 14 configured to support air fluidization bed 12 above ground. Air fluidization bed 12 is configured to provide minimal shear and frictional force to the skin of a patient occupying patient support apparatus 10. As such, a patient who has highly compromised skin may be positioned on air fluidization bed 12 to receive treatment.

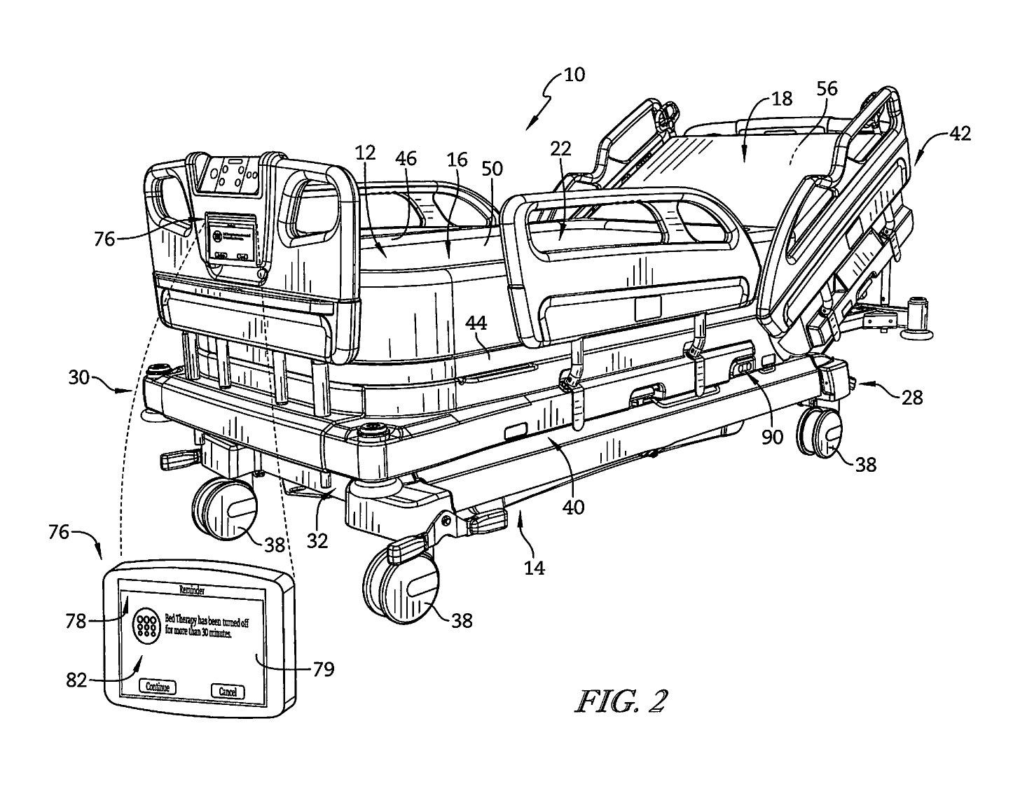

In the illustrative embodiment, air fluidization bed 12 includes a fluidization system 26, a tank assembly 16, a head end support assembly 18, and a quick release handle 90 as shown in FIG. 2. Tank assembly 16 includes a fluidization space 22 and a fluidizable medium 24 positioned in fluidization space 22 shown in FIG. 1. Tank assembly 16 is configured to receive a flow of pressurized air from fluidization system 26 to fluidize fluidizable medium 24 to cause tank assembly 16 to provide air fluidized therapy to a patient supported on air fluidization bed 12. Head end support assembly 18 includes a plurality of fluid bladders 56. Head end support assembly 18 is configured to variably incline relative to tank assembly 16 as suggested in FIGS. 1 and 2. Quick release handle 90 is configured to cause head end support assembly 18 to rapidly lower into a horizontal position and to instruct fluidization system 26 to draw down at least one of the plurality of fluid bladders 56 when quick release handle 90 is activated.

Illustratively, patient support apparatus 10 further includes a control interface 76 and a controller 70. Control interface 76 is configured to allow a user to initiate and stop the air fluidized therapy as shown in FIG. 2. Controller 70 is configured to instruct control interface 76 to display a notification informing the user that the air fluidization therapy has been stopped for a predetermined amount of time after the air fluidization therapy has been stopped for the predetermined amount of time as suggested in FIG. 2.

Air fluidization bed 12 illustratively includes tank assembly 16, head end support assembly 18, and fluidization system 26 as shown in FIGS. 1 and 2. Tank assembly 16 is formed to define fluidization space 22 and fluidizable medium 24, embodied as silica beads, is positioned in fluidization space 22. Fluidization system 26 is configured to provide a high volume of pressurized air to tank 20 to fluidize fluidizable medium 24. Head end support assembly 18 is configured to support an upper portion of the patient and to variably incline relative to tank assembly 16.

Carriage 14 is configured to support air fluidization bed 12 and includes a lower frame 28, an upper frame 30, and a support system 32 supporting upper frame 30 on lower frame 28. In one illustrative embodiment, support system 32 includes a lift system 32 actuated by a Hi/Lo actuator 34 configured to cause lift system 32 to raise and/or lower upper frame 30 with respect to lower frame 28. In illustrative embodiments, lower frame 28 is supported by casters 38 to help with transport of patient support apparatus 10.

Upper frame 30 supports air fluidization bed 12 as shown in FIG. 1. Upper frame 30 includes a foot deck section 40 configured to support tank assembly 16 and a head deck section 42 configured to support head end support assembly 18. Head deck section 42 is configured to variably incline with respect to foot deck section 40 to move a person supported on air fluidization bed 12 between a substantially horizontal position, shown in FIG. 1, and a reclined or elevated position, shown in FIG. 2, by varying a Head of Bead (HOB) angle. In other embodiments, air fluidization bed 12 does not include head end support assembly 18 and instead, tank assembly 16 extends a length of upper frame 30.

Air fluidization bed 12 illustratively includes tank assembly 16, head end support assembly 18, and fluidization system 26 as shown in FIGS. 1 and 2. Tank assembly 16 is configured to support a pelvic region and lower extremities of a person as shown in FIG. 1. Head end support assembly 18 is configured to support a person's head and/or torso.

Tank assembly 16 includes a tank base 44, a tank liner 46, a tank bladder 48, and a filter sheet 50 as shown in FIGS. 1 and 2. In one illustrative embodiment, tank base 44 and tank liner 46 are made of a low or substantially no air-loss material, such as, for example, a polyurethane-backed nylon fabric material, and tank bladder 48 is composed of a substantially no air loss polymeric material and filled with a fluid, such as, air.

Tank base 44 is coupled to upper frame 30 by tank fasteners (not shown) and includes an inlet 60 that couples to fluidization system 26. Tank liner 46 and tank bladder 48 are coupled together to form the sides of tank assembly 16. Tank base 44, tank liner 46, tank bladder 48, and filter sheet 50 cooperate to define space 22 therebetween that contains fluidizable medium 24.

Filter sheet 50 is configured to allow fluid, such as, bodily fluids and air, to pass therethrough while preventing fluidizable medium 24 from passing through. Filter sheet 50 is also configured to provide sufficient support to minimize or eliminating hammocking from occurring when a patient is supported by fluidized fluidizable medium 24 so that the patient is properly supported. Filter sheet 50 is positioned over space 22 and is coupled to tank liner 46 as shown in FIG. 1. Filter sheet 50 is coupled to tank liner 46 by fasteners which may be zippers, buttons, snaps, turn-buttons, hook and loop fasteners, or any other suitable alternative.

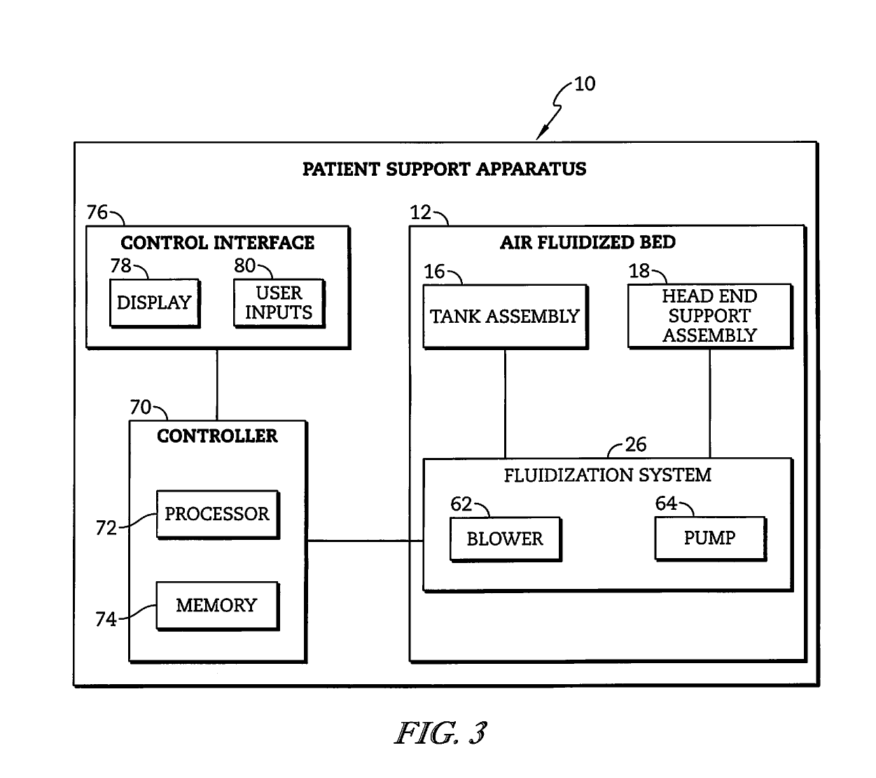

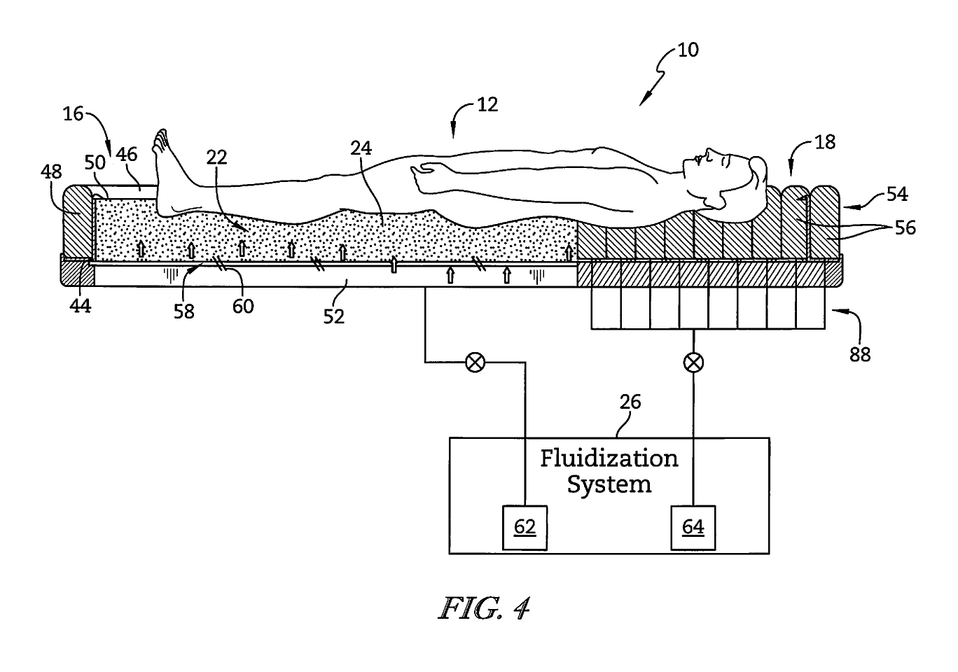

Tank assembly 16 further includes a diffuser 52 configured to support fluidizable medium 24 thereon and provide substantially uniform fluid flow to fluidizable medium 24 from fluidization system 26 as suggested, for example, in FIGS. 3 and 4. Air supplied by fluidization system 26 passes through diffuser 52 and into fluidizable medium 24 to cause fluidizable medium 24 to become fluidized.

Head end support assembly 18 includes a person support surface 54 or mattress 54 composed of fluid bladders 56 (sometimes called inflatable bladders) in the illustrative embodiment. Fluid bladders 56 are configured to be inflated, such as with air, to a pressure which is optimized to reduce the incidence of the development of decubitus ulcers, also known as bedsores.

In the embodiment shown in FIG. 1, head end support assembly 18 is configured to variably incline with respect to tank assembly 16 to move a person supported on patient support apparatus 10 between a substantially horizontal position and a reclined or elevated position by varying a Head of Bead (HOB) angle as shown in FIGS. 1 and 2. FIG. 1 shows patient support apparatus in the substantially horizontal position in which head end support assembly 18 is not angled relative to tank assembly 16. FIG. 2 shows patient support apparatus in a reclined or elevated position in which head end support assembly 18 is angled relative to tank assembly 16. In another embodiment, person support surface 54 includes foam (not shown) and/or a combination of foam and fluid bladders 56.

Referring now to FIGS. 3 and 4, fluidization system 26 is pneumatically coupled to inlet 60 which conveys air from fluidization system 26 into a space 58 formed between a tank bottom and diffuser 52. Space 58 acts as a manifold so that air transferred into space 58 is evenly distributed throughout space 58 and urged through diffuser 52. When the pressure in space 58 becomes excessive, air flows through diffuser 52 into fluidizable medium 24 and creates an air fluidization bed for supporting a patient. Filter sheet 50 further limits the flow of air so that the patient “floats” on air fluidization bed 12. Air fluidization therapy (AFT) spreads the weight of the patient over a surface of air fluidization bed 12 and reduces the interface pressure experienced by the patient's skin on air fluidization bed 12.

Fluidization system 26 includes a variable speed blower 62 that is operable to vary the volume of air flowing into inlet 60. In the illustrative embodiment, fluidization system 26 further includes a pump 64 configured to inflate bladders 56 and to apply a vacuum to fluid bladders 56 to draw down fluid bladders 56 by application of vacuum or negative pressure. As an example, pump 64 is configured to draw down fluid bladders 56 and other fluid bladders included in patient support apparatus 10 when a patient is exiting patient support apparatus 10. As shown in FIG. 4, pump 64 is fluidly coupled to a manifold 88. As such, each bladder 56 may be inflated and deflated independent of the other bladders 56.

Patient support apparatus 10 further includes a controller 70 that operates fluidization system 26 as shown in FIG. 3. Controller 70 includes a processor 72 and a memory 74. Processor 72 is in communication with memory device 74. Memory device 74 includes instructions that, when executed by processor 72, cause processor 72 to control operation of patient support apparatus 10.

In addition, patient support apparatus 10 includes control interface 76 that includes a display 78 and a plurality of user inputs 80 that are operable to change the operation of patient support apparatus 10 as shown in FIG. 3. For example, a user may use control interface 76 to initiate and stop air fluidized therapy. In addition, a user may vary a speed of blower 62 to adjust the fluidization of fluidizable medium 24. In the illustrative embodiment, control interface 76 includes a touchscreen 79 that also includes user inputs 80 on the display. In other embodiments, display 78 may be a simple multi-segment LED display and user inputs 80 may be discrete buttons or switches.

Air fluidization bed 12 is configured to provide air fluidization therapy to a patient supported on patient support apparatus 10. Air fluidized therapy may be stopped such that air fluidization bed 12 no longer provides the desired support for improving healing conditions. For example, air fluidized therapy may be stopped when the patient is exiting air fluidization bed 12 or while a second therapy is performed. Air fluidization therapy may be stopped intentionally or unintentionally for a plurality of reasons. The patient or a caregiver of the patient may forget to re-initiate the air fluidized therapy after the patient returns to air fluidization bed 12 or after the second therapy ends.

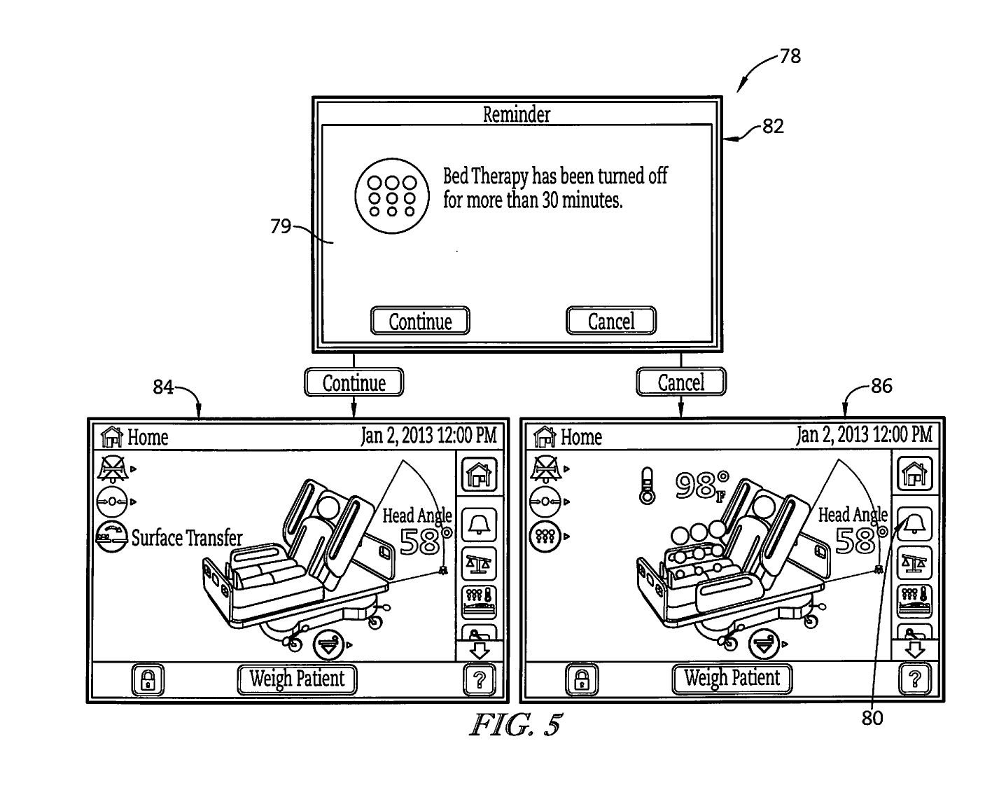

Controller 70 is configured to instruct control interface 76 to display a notification screen 82 informing the user or caregiver that air fluidization therapy has been stopped for a predetermined amount of time after the predetermined amount of time has elapsed as shown in FIG. 5. In the illustrative embodiment, a notification on screen 82 is displayed after air fluidization therapy has been stopped for more than thirty minutes. In some embodiments, the notification screen 82 is displayed for as long as patient support apparatus 10 is powered on. In other embodiments, the conditions for displaying the notification screen 82 may be adjusted. For example, a user may set a condition that the notification screen 82 will not be displayed if patient support apparatus 10 does not detect a patient supported on patient support apparatus 10. In some embodiments, a notification is displayed if patient support apparatus 10 does not detect a patient supported on patient support apparatus 10.

In the illustrative example, the notification displayed on notification screen 82 states “Bed Therapy has been turned off for more than 30 minutes.” “Continue” and “Cancel” buttons or icons are also shown on notification screen 82 as shown in FIG. 5. If the user chooses “Continue,” air fluidized therapy remains turned off as suggested in screen 84 in FIG. 5. If the user chooses “Cancel,” air fluidized therapy is initiated as suggested in screen 86 in FIG. 5 by the bubble icons over the depicted patient avatar's leg region.

In some embodiments, patient support apparatus 10 is connected with a hospital network (not shown). Controller 70 may be configured to send the notification and other information relating to the air fluidized therapy to a nurse call station, remote computer, etc. In some embodiments, patient support apparatus 10 has a wired connection with the hospital network. In other embodiments, patient support apparatus 10 has a wireless connection with the hospital network.

Patient support apparatus 10 further includes quick release handle 90 as shown in FIG. 2. lf, when head end support assembly 18 is in a raised position such as that shown in FIG. 2, a patient experiences a trauma such as a heart attack, it is important to rapidly lower head end support assembly 18 to a horizontal position so that appropriate medical care such as cardio-pulmonary resuscitation (CPR) can be administered. A caregiver may move head end support assembly 18 to the horizontal position substantially faster than is possible using the motor in a drive mechanism, or in situations where head end support assembly must be manually moved in the absence of electric power, by manually pulling quick release handle 90.

In the illustrative embodiment, controller 70 stops air fluidized therapy when quick release handle 90 is pulled. If air fluidized therapy is not re-initiated after quick release handle 90 is pulled, control interface 76 will display notification screen 82, as discussed above, informing the user or caregiver that air fluidization therapy has been stopped for the predetermined amount of time after the predetermined amount of time has elapsed.

Illustratively, pump 64 is instructed or controlled to apply a vacuum to fluid bladders 56 included in head end support assembly 18 to draw down fluid bladders 56 when quick release handle 90 is pulled. In the illustrative embodiment, fluid bladders 56 are drawn down to head deck section 42 when quick release handle 90 is pulled. In other embodiments, fluid bladders 56 are drawn down as far as possible, such as down to a foam base layer situated beneath bladders 56, when quick release handle 90 is pulled.

The patient's lower body is partially immersed in fluidizable medium 24 when air fluidized therapy is stopped as suggested in FIG. 4. If fluid bladders 56 are fully or partially inflated when fluidizable medium is stopped, the patient's upper body likely will be supported at a higher elevation than their lower body. As a result, the patient's upper body may lie at an angle up to about ten degrees relative to their lower body. Complications may occur if the patient is lying at such an angle during a trauma or during treatment of a trauma such as, for example, CPR. Drawing down (or deflating) fluid bladders 56 and moving head end support assembly 18 to the horizontal position when quick release handle 90 is pulled reduces or eliminates the angle of the patient's upper body relative to their lower body.

Although certain illustrative embodiments have been described in detail above, variations and modifications exist within the scope and spirit of this disclosure as described and as defined in the following claims.

1. An air fluidization therapy bed comprising:
a tank assembly including a fluidization space and a fluidizable medium positioned in the fluidization space, the tank assembly configured to receive a flow of pressurized air from an air supply to fluidize the fluidizable medium to cause the tank assembly to provide air fluidized therapy to a patient supported on the air fluidization therapy bed;
a control interface configured to allow a user to initiate and stop the air fluidized therapy; and
a controller configured to instruct the control interface to display a notification informing the user that the air fluidized therapy has been stopped for a predetermined amount of time after the air fluidized therapy has been stopped for the predetermined amount of time.

2. The air fluidization therapy bed of claim 1, wherein the predetermined amount of time is about 30 minutes.

3. The air fluidization therapy bed of claim 2, further comprising a head section that includes a plurality of inflatable support bladders, the head section configured to variably incline relative to the tank assembly.

4. The air fluidization therapy bed of claim 1, wherein the controller is further configured to detect if a patient is supported on the air fluidization therapy bed and the controller instructs the control interface to display the notification only if a patient is detected.

5. The air fluidization therapy bed of claim 1, further comprising a head end support assembly including a plurality of inflatable bladders, the head end support assembly configured to variably incline relative to the tank assembly; and a quick release handle configured to cause the head end support assembly to rapidly lower into a horizontal position and to signal the controller to draw down at least one of the plurality of inflatable bladders when the quick release handle is activated.

6. The air fluidization therapy bed of claim 5, further comprising a second air supply and wherein the second air supply is signaled by the controller to draw down each of the plurality of inflatable bladders in response to the quick release handle being activated.

7. The air fluidization therapy bed of claim 6, wherein drawing down at least one of the plurality of inflatable bladders applying a vacuum to the at least one inflatable bladder.

8. The air fluidization therapy bed of claim 6, wherein drawing down at least one of the plurality of inflatable bladders comprises completely deflating all of the inflatable bladders of the plurality of inflatable bladders.

9. The air fluidization therapy bed of claim 6, wherein the controller is configured to instruct the air supply to stop the air fluidized therapy in response to the quick release handle being activated.

10. The air fluidization therapy bed of claim 1, wherein the controller is further configured to detect if a patient is supported on the air fluidization therapy bed and the controller instructs the control interface to display the notification only if a patient is detected.

11. The air fluidization therapy bed of claim 1, wherein the control interface displays a first user input that is selectable by the user to continue with the stoppage of the air fluidized therapy.

12. The air fluidization therapy bed of claim 11, wherein the control interface displays a second user input that is selectable by the user to restart the air fluidized therapy.

13. A method of operating an air fluidization therapy bed comprising:
reclining a head end support assembly included in the air fluidization therapy bed relative to a tank assembly in response to a quick release handle being pulled, the tank assembly including a fluidization space and a fluidizable medium positioned in the fluidization space and the head end support assembly having a plurality of inflatable bladders, the tank assembly configured to provide air fluidized therapy to a patient supported on the air fluidization therapy bed, and the head end support assembly configured to variably incline relative to the tank assembly; and
drawing down with a vacuum the plurality of inflatable bladders included in the head end support assembly in response to the quick release handle being pulled.

14. The method of claim 13, further comprising stopping air fluidization therapy being provided by the air fluidization therapy bed in response to the quick release handle being pulled.

15. The method of claim 14, further comprising displaying a notification screen on a graphical interface that the air fluidization therapy has been stopped for a predetermined amount of time after the predetermined amount of time has passed.

16. The method of claim 15, wherein the notification screen includes an option to turn on the air fluidization therapy.

17. The method of claim 13, wherein reclining the head end support assembly and drawing down the inflatable bladders causes an upper body portion of the patient to have less than a 10 degree incline relative to a lower body portion of the patient.

18. The method of claim 17, wherein drawing down with a vacuum the plurality of inflatable bladders completely deflates the plurality of inflatable bladders.

19. A method of operating an air fluidization therapy bed comprising:
stopping an air fluidization therapy provided by the air fluidization therapy bed, the air fluidization therapy bed comprising a tank assembly including a fluidization space and a fluidizable medium positioned in the fluidization space, the tank assembly configured to receive a flow of pressurized air to fluidize the fluidizable medium to cause the tank assembly to provide air fluidized therapy to a patient supported on the air fluidization therapy bed; and
displaying a notification screen on a control interface included in the air fluidization therapy bed that the air fluidization therapy has been stopped for a predetermined amount of time after the predetermined amount of time has passed.

20. The method of claim 19, wherein the notification screen includes an option to turn on the air fluidization therapy.
